(19) United States
(12) Patent Application Publication
(10) Pub. No.: US 2020/0125022 A1
(43) Pub. Date: Apr. 23, 2020

(54) RESIN SHEET, SHEET CONVEYING DEVICE, AND IMAGE FORMING APPARATUS

(71) Applicant: Naoki Matsuda, Kanagawa (JP)

(72) Inventor: Naoki Matsuda, Kanagawa (JP)

(73) Assignee: Ricoh Company, Ltd., Tokyo (JP)

(21) Appl. No.: 16/566,105

(22) Filed: Sep. 10, 2019

(30) Foreign Application Priority Data
Oct. 17, 2018 (JP) 2018-195581

(51) Int. Cl. G03G 15/00; B65H 9/00; B65H 5/06

(52) U.S. Cl. CPC G03G 15/6529; B65H 5/06; B65H 9/002

(57) ABSTRACT

A resin sheet includes a coating layer disposed at a contact portion at which the resin sheet contacts a surface mover having a surface that moves endlessly. A sheet conveying device includes a sheet conveying roller configured to convey a sheet, and the resin sheet. An image forming apparatus includes a sheet conveying roller configured to convey a sheet, and the resin sheet.

### CROSS-REFERENCE TO RELATED APPLICATION

This patent application is based on and claims priority pursuant to 35 U.S.C. § 119(a) to Japanese Patent Application No. 2018-195581, filed on Oct. 17, 2018, in the Japan Patent Office, the entire disclosure of which is hereby incorporated by reference herein.

### BACKGROUND

### Technical Field

This disclosure relates to a resin sheet, a sheet conveying device, and an image forming apparatus.

### Related Art

Various types of resin sheets are known to contact a surface mover having a surface that moves endlessly.

For example, a known resin sheet has one end fixed to a guide plate that guides a sheet and the other end in contact with a conveying roller that functions as a surface mover.

### SUMMARY

At least one aspect of this disclosure provides a resin sheet including a coating layer disposed at a contact portion at which the resin sheet contacts a surface mover having a surface that moves endlessly.

Further, at least one aspect of this disclosure provides a sheet conveying device including a sheet conveying roller configured to convey a sheet, and the above-described resin sheet configured to contact the sheet conveying roller.

Further, at least one aspect of this disclosure provides an image forming apparatus including a sheet conveying roller configured to convey a sheet, and the above-described resin sheet configured to contact the sheet conveying roller.

### BRIEF DESCRIPTION OF THE SEVERAL VIEWS OF THE DRAWINGS

An exemplary embodiment of this disclosure will be described in detail based on the following figured, wherein:

FIG. 1 is a diagram illustrating an overall configuration of an image forming apparatus according to Embodiment 1 of this disclosure;

FIG. 2 is a diagram illustrating an image forming unit according to Embodiment 1 of this disclosure;

FIG. 3 is a diagram illustrating a sheet conveyance passage of a sheet;

FIG. 4 is an enlarged view illustrating a pair of registration rollers and an area near the pair of registration rollers (Area A in FIG. 3);

FIG. 5 is a perspective view illustrating a conveyance mechanism that holds the pair of registration rollers and a secondary transfer roller;

FIG. 6 is a front view illustrating the conveyance mechanism, viewed from a direction indicated by arrow W of FIG. 5;

FIG. 7 is a diagram illustrating an example of a leading end of a guide sheet;

FIG. 8 is a diagram illustrating the leading end of the guide sheet coated with a coating layer;

FIGS. 9A and 9B are diagrams illustrating another example of a coating layer;

FIGS. 10A, 10B, and 10C are diagrams illustrating examples of forming a coating layer of a guide sheet having no burr at the leading end;

FIG. 11 is a diagram illustrating a schematic configuration of an image forming apparatus according to Embodiment 2 of this disclosure;

FIG. 12 is a diagram illustrating a schematic configuration of the image forming apparatus, focusing a pair of registration rollers and an area near the pair of registration rollers, according to Embodiment 2 of this disclosure;

FIG. 13 is a perspective view illustrating a conveyance mechanism, viewed from a second registration roller of the pair of registration rollers; and

FIG. 14 is a perspective view illustrating the conveyance mechanism, viewed from a first registration roller of the pair of registration rollers.

### DETAILED DESCRIPTION

It will be understood that if an element or layer is referred to as being “on”, “against”, “connected to” or “coupled to” another element or layer, then it can be directly on, against, connected or coupled to the other element or layer, or intervening elements or layers may be present. In contrast, if an element is referred to as being “directly on”, “directly connected to” or “directly coupled to” another element or layer, then there are no intervening elements or layers present. Like numbers referred to like elements throughout. As used herein, the term “and/or” includes any and all combinations of one or more of the associated listed items.

Spatially relative terms, such as “beneath”, “below”, “lower”, “above”, “upper” and the like may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements describes as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors herein interpreted accordingly.

Although the terms first, second, etc. may be used herein to describe various elements, components, regions, layers and/or sections, it should be understood that these elements, components, regions, layer and/or sections should not be limited by these terms. These terms are used to distinguish one element, component, region, layer or section from another region, layer or section. Thus, a first element, component, region, layer or section discussed below could be termed a second element, component, region, layer or section without departing from the teachings of the present disclosure.

The terminology used herein is for describing particular embodiments and examples and is not intended to be limiting of exemplary embodiments of this disclosure. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Descriptions are given, with reference to the accompanying drawings, of examples, exemplary embodiments, modification of exemplary embodiments, etc., of a resin sheet, a sheet conveying device, and an image forming apparatus according to exemplary embodiments of this disclosure. Elements having the same functions and shapes are denoted by the same reference numerals throughout the specification and redundant descriptions are omitted. Elements that do not demand descriptions may be omitted from the drawings as a matter of convenience. Reference numerals of elements extracted from the patent publications are in parentheses so as to be distinguished from those of exemplary embodiments of this disclosure.

This disclosure is applicable to any resin sheet, and is implemented in the most effective manner in any electrophotographic image forming apparatus.

In describing preferred embodiments illustrated in the drawings, specific terminology is employed for the sake of clarity. However, the disclosure of this disclosure is not intended to be limited to the specific terminology so selected and it is to be understood that each specific element includes any and all technical equivalents that have the same function, operate in a similar manner, and achieve a similar result.

Referring now to the drawings, wherein like reference numerals designate identical or corresponding parts throughout the several views, preferred embodiments of this disclosure are described.

Descriptions are given of an embodiment applicable to a resin sheet, a sheet conveying device, and an image forming apparatus, with reference to the following figures.

It is to be noted that elements (for example, mechanical parts and components) having the same functions and shapes are denoted by the same reference numerals throughout the specification and redundant descriptions are omitted.

Now, a description is given of an electrophotographic image forming apparatus 300 for forming images by electrophotography, according to Embodiment 1 of this disclosure. It is to be noted that, hereinafter, the electrophotographic image forming apparatus 300 is referred to as the image forming apparatus 300.

Further, size (dimension), material, shape, and relative positions used to describe each of the components and units are examples, and the scope of this disclosure is not limited thereto unless otherwise specified.

First, a description is given of the configuration and operations of the image forming apparatus 300, with reference to the drawings.

In Embodiment 1, the image forming apparatus 300 is a printer but is not limited to the printer. For example, this disclosure is applicable to a copier, a facsimile machine, a printing machine, a multifunctional apparatus including at least two functions of the copier, the facsimile machine, and the printing machine.

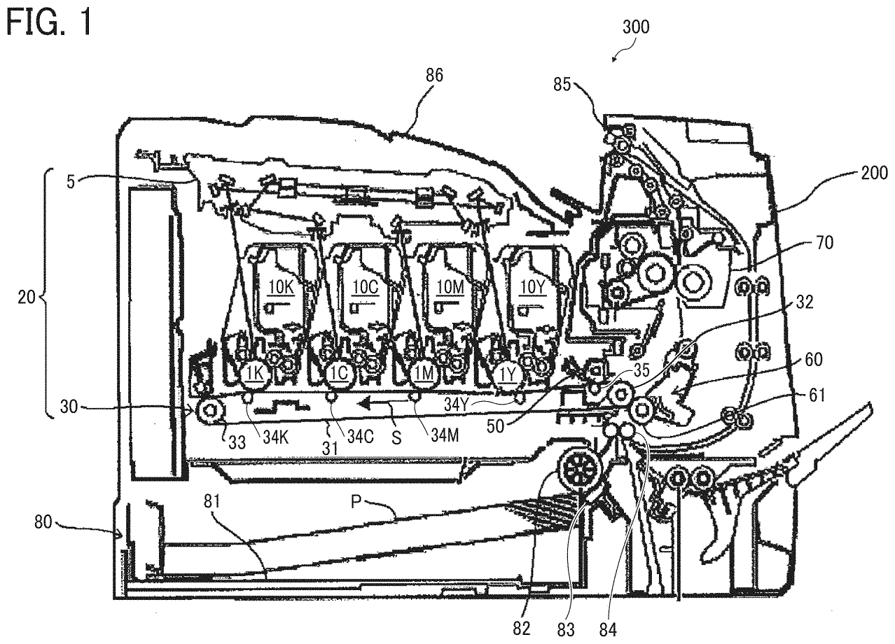

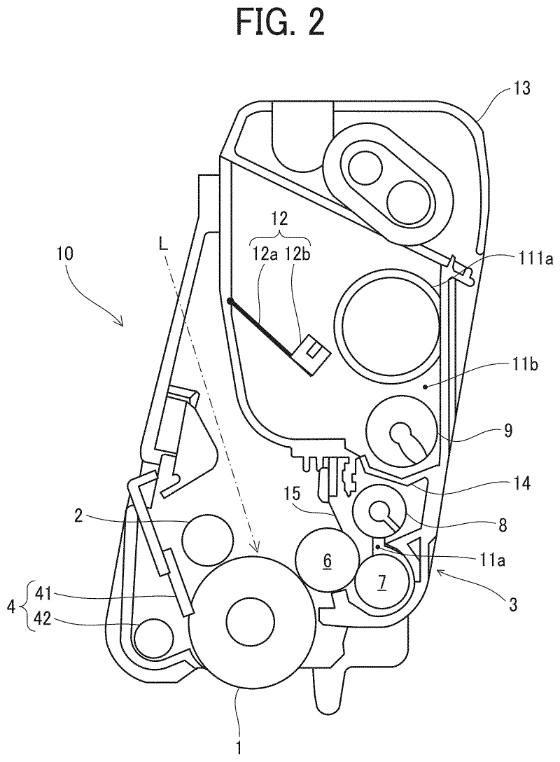

Here, FIG. 1 is a diagram illustrating an overall configuration of the image forming apparatus 300 according to Embodiment 1 of this disclosure. FIG. 2 is a diagram illustrating an image forming unit 10 according to Embodiment 1 of this disclosure.

The image forming apparatus 300 according to Embodiment 1 is a tandem color laser printer using four color toners of yellow (Y), magenta (M), cyan (C), and black (K). As illustrated in FIG. 1, a sheet feeding part 80 is provided to a lower part of an apparatus body 200 of the image forming apparatus 300. The sheet feeding part 80 includes a sheet feed tray 81 that loads a sheet-shaped recording medium such as a recording sheet (hereinafter, referred to as a sheet P). An image forming part 20 is disposed above the sheet feeding part 80.

Next, a description is given of configurations and functions of the sheet feeding part 80 and an image forming part 20.

In the image forming part 20, image forming units 10Y, 10M, 10C, and 10K corresponding to the respective colors are disposed in order of Y, M, C, and K from the right side in FIG. 1 along an extending direction of an intermediate transfer belt 31 of an intermediate transfer unit 30 disposed below the image forming units 10Y, 10M, 10C, and 10K. Hereinafter, the image forming units 10Y, 10M, 10C, and 10K are occasionally referred to, in a singular form, as the “image forming unit 10”.

An optical writing device 5 is disposed above the image forming units 10Y, 10M, 10C, and 10K. A secondary transfer unit 60 is disposed on the right side of the intermediate transfer unit 30 in FIG. 1, and a fixing device 70 is disposed above the secondary transfer unit 60.

The image forming units 10Y, 10M, 10C, and 10K include photoconductor drums 1Y, 1M, 1C, and 1K, respectively. The photoconductor drums 1Y, 1M, 1C, and 1K function as latent image bearers. The image forming unit 10 (i.e., the image forming units 10Y, 10M, 10C, and 10K) includes a housing to collectively include a charging roller 2, a developing device 3, and a cleaning device 4, corresponding to the photoconductor drum 1 (i.e., the photoconductor drums 1Y, 1M, 1C, and 1K) for each color. The image forming units 10Y, 10M, 10C, and 10K have respective configurations identical to each other, except that the colors used in the image forming units 10Y, 10M, 10C, and 10K are different from each other. Therefore, in the following description, the symbols Y, M, C, and K are omitted appropriately.

As illustrated in FIG. 2, the image forming unit 10 includes the photoconductor drum 1, the charging roller 2 that functions as a charger to uniformly charge a surface of the photoconductor drum 1 while contacting, and the developing device 3 including a developing roller 6 that functions as a developer carrier. The image forming unit 10 further includes the cleaning device 4 including a cleaning blade 41 to contact a surface of the photoconductor drum 1.

The developing device 3 includes a toner supplying chamber 11a and a toner storing chamber 11b. The toner supplying chamber 11a is disposed below the toner storing chamber 11b that contains toner that functions as developer. A partition 14 is disposed between the toner supplying chamber 11a and the toner storing chamber 11b.

A toner conveying member 9 is disposed in the toner storing chamber 11b to convey the toner contained in the toner storing chamber 11b in a direction parallel to a rotation shaft of the photoconductor drum 1 (in other words, in an axial direction perpendicular to the drawing sheet of FIG. 2). Further, an agitator 12 is disposed to function as a toner agitator. The agitator 12 includes an agitator rotation shaft 12b and a PET sheet 12a that is fixed to the agitator rotation shaft 12b. As the PET sheet 12a rotates about the agitator rotation shaft 12b while contacting the inner wall of the toner storing chamber 11b, the whole toner in the toner storing chamber 11b is agitated.

A toner supplying port 111a is used when unused toner (in other words, new toner) is replenished into the toner storing chamber 11b and is used to function as an air supplying port when air is blown to clean the toner storing chamber 11b.

A toner layer regulating member 15 that functions as a developer regulator is disposed to contact the surface of the developing roller 6 that is disposed downstream from the position at which the supply roller 7 contacts the developing roller 6 in a surface moving direction of the developing roller 6.

A toner agitating member 8 is disposed above the supply roller 7 in the toner supplying chamber 11a to agitate the toner in the toner supplying chamber 11a.

As image forming operation starts, the charging roller 2 uniformly charges (initializes by charging at high potential) the surface of the photoconductor drum 1 rotating clockwise in FIG. 2 in the dark. A laser beam L based on image data is irradiated from the optical writing device 5 to the uniformly charged surface of the photoconductor drum 1. According to this irradiation, an electrostatic latent image including a low potential portion having a potential attenuated and a high potential portion due to the uniform charging is formed on the surface of the photoconductor drum 1. The developing device 3 includes a supply roller 7 to supply developer to the developing roller 6. Along with rotations of the photoconductor drum 1, the developing device 3 transfers toner that is carried by the developing roller 6, to the low potential portion (or high potential portion) of the electrostatic latent image, so as to develop a toner image (visualization processing). Thereafter, as the photoconductor drum 1 rotates, the developed toner image is conveyed toward a primary transfer area facing the intermediate transfer belt 31 of the intermediate transfer unit 30. Then, the toner image is transferred onto the intermediate transfer belt 31 by a primary transfer bias applied to a primary transfer roller 34 (i.e., primary transfer rollers 34Y, 34M, 34C, and 34K) facing the photoconductor drum 1 via the intermediate transfer belt 31.

Residual toner remaining on the surface of the photoconductor drum 1 without being transferred at the primary transfer area is scraped by the cleaning blade 41 of the cleaning device 4 that is disposed on a downstream side in a rotational direction of the photoconductor drum 1 and is in contact with the surface of the photoconductor drum 1. The residual toner scraped off by the cleaning blade 41 becomes waste toner to be conveyed to a waste toner collecting unit by a conveying screw 42 of the cleaning device 4.

The above-described electrostatic latent image is formed and the above-described toner image is developed from the electrostatic latent image. As illustrated in FIG. 1, these image formations are sequentially performed in the image forming unit 10 by setting a timing in each of the image forming unit 10. Then, the toner images of the respective colors are primarily transferred onto the intermediate transfer belt 31 traveling in the direction indicated by arrow S (on the left side of the drawing) such that an upper extended surface is sequentially superposed from each of the photoconductor drums 1Y, 1M, 1C, and 1K, and a full-color toner image is carried on the intermediate transfer belt 31.

The intermediate transfer unit 30 includes the intermediate transfer belt 31 that carries a toner image, a secondary transfer backup roller 32 that functions as a drive roller stretching the intermediate transfer belt 31 at both ends on an inner circumferential side of the intermediate transfer belt 31, and a tension roller 33. As described above, the intermediate transfer belt 31 is stretched mainly by two rollers, which are the secondary transfer backup roller 32 (that functions as a drive roller) and the tension roller 33. According to this configuration, the size of the intermediate transfer unit 30 is reduced. On the inner circumferential side of the intermediate transfer belt 31, primary transfer rollers 34Y, 34M, 34C, and 34K and a cleaning opposed roller 35. The primary transfer rollers 34Y, 34M, 34C, and 34K are made of metal and are disposed facing the respective photoconductor drums 1Y, 1M, 1C, and 1K, via the intermediate transfer belt 31.

The intermediate transfer unit 30 further includes a holding member that rotatably holds these rollers at both ends. In a state in which tension is applied to the intermediate transfer belt 31 by the tension roller 33, the intermediate transfer belt 31 is rotationally driven, that is, driven for traveling by rotation of the secondary transfer backup roller 32 that functions as a drive roller. Here, as the intermediate transfer belt 31, an endless belt formed of a base body made of a heat-resistant material such as polyimide, polyamide, polycarbonate, or TPE and adjusted to medium resistance is used.

On an outer circumferential side of the intermediate transfer belt 31, a belt cleaning device 50 is disposed on a downstream side of the secondary transfer unit in a belt traveling direction. The belt cleaning device 50 cleans residual toner remaining on the intermediate transfer belt 31 without being transferred after the secondary transfer onto the sheet P. That is, the belt cleaning device 50 is disposed on a downstream side of the secondary transfer backup roller 32 in a belt traveling direction on an upper extended surface of the intermediate transfer belt 31 stretched by the secondary transfer backup roller 32 and the tension roller 33 at a position on an upstream side of the image forming unit 10Y.

The full-color toner image transferred onto and carried on the intermediate transfer belt 31 is collectively transferred onto the sheet P conveyed from the sheet feeding part 80 by the secondary transfer unit 60. That is, the sheet P fed out from the sheet feed tray 81 included in the sheet feeding part 80 illustrated in FIG. 1 by a sheet feed roller 82 is separated into one sheet by a friction pad 83 in the middle of sheet conveyance. The sheet P separated into one sheet is conveyed by a pair of registration rollers 84 toward a secondary transfer position at which the secondary transfer roller 61 of the secondary transfer unit 60 and the secondary transfer backup roller 32 are disposed so as to face each other via the intermediate transfer belt 31. The pair of registration rollers 84 that functions as a sheet conveying roller and a surface mover conveys the sheet P in synchronization with movement of a full-color toner image conveyed while being carried on the intermediate transfer belt 31. The full-color toner image on the intermediate transfer belt 31 is secondarily transferred collectively at the secondary transfer position. In the intermediate transfer belt 31 after the transfer, residual toner remaining on the surface of the intermediate transfer belt 31 is removed by the belt cleaning device 50 disposed downstream from the secondary transfer backup roller 32 in a belt traveling direction, and the intermediate transfer belt 31 is ready for transfer of a subsequent toner image.

The belt cleaning device 50 includes a belt cleaning blade that faces the cleaning opposed roller 35 via the intermediate transfer belt 31 and scrapes off residual toner remaining on the intermediate transfer belt 31 for cleaning. Residual toner scraped off from the intermediate transfer belt 31 by the belt cleaning blade is conveyed toward a waste toner collecting unit. The residual toner conveyed to the waste toner collecting unit is considered as waste toner.

After the sheet P has passed the secondary transfer position, the full-color toner image that has been secondarily transferred is formed on the sheet P. The sheet P is then conveyed along a sheet conveyance passage, fixed by the fixing device 70, and then ejected onto a sheet ejection tray 86 that functions as a loading unit, via a sheet ejection roller 85. Thus, a series of image forming operations is completed, and the image forming apparatus 300 is ready for formation of a subsequent image.

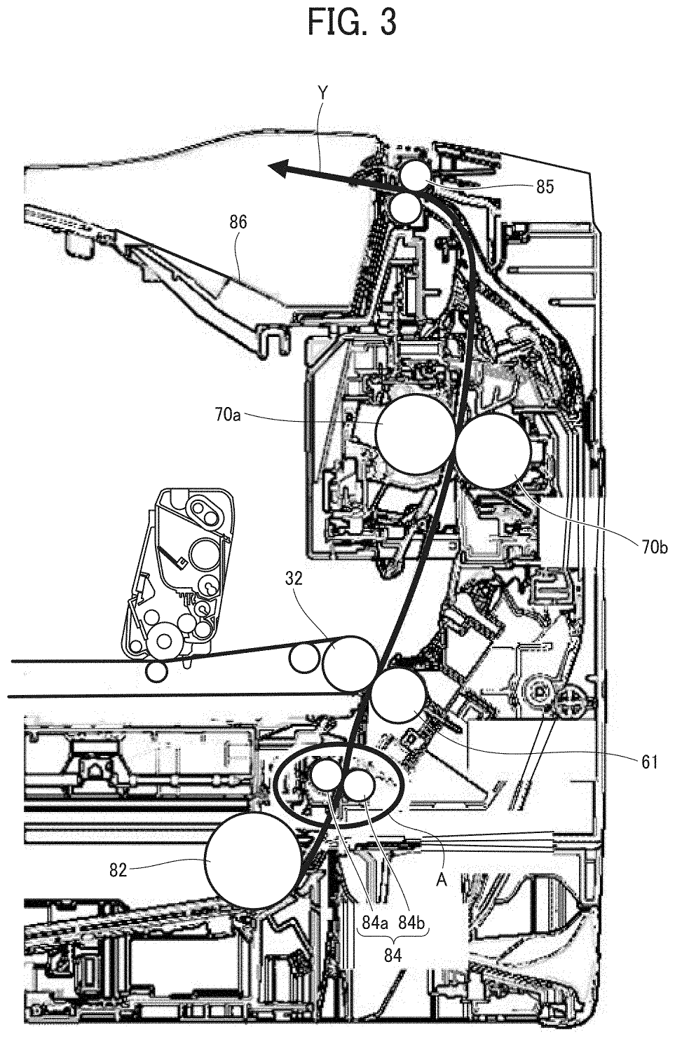

FIG. 3 is a diagram illustrating a sheet conveyance passage Y of a sheet P.

The sheet P that has been set substantially horizontally in the sheet feed tray 81 is conveyed by the sheet feed roller 82. The sheet P is conveyed toward the pair of registration rollers 84 so as to rise while being guided by a guide member. Thereafter, the sheet P is conveyed in a substantially vertical direction and passes a secondary transfer nip region and a fixing nip region formed by a fixing roller 70a and a pressure roller 70b of the fixing device 70. The sheet P is guided so as to be laid by the guide member, and then is ejected to the sheet ejection tray 86 by the sheet ejection roller 85.

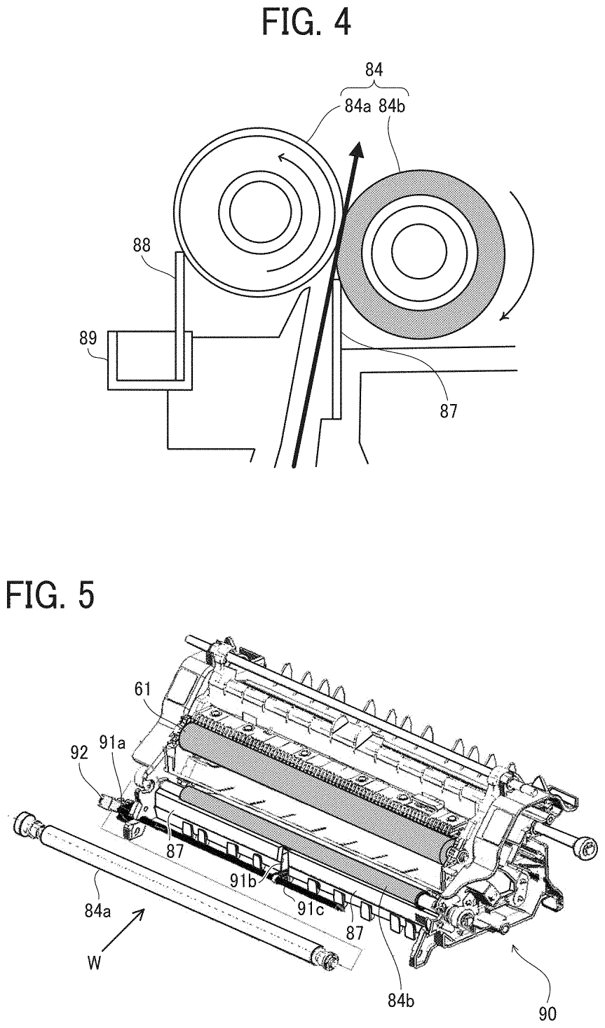

FIG. 4 is an enlarged view illustrating the pair of registration rollers 84 and an area near the pair of registration rollers 84 (Area A in FIG. 3).

The pair of registration rollers 84 includes a first registration roller 84a and a second registration roller 84b. The first registration roller 84a and the second registration roller 84b form a secondary transfer nip region. The first registration roller 84a that functions as a surface mover is a metal roller disposed on a side closer to the intermediate transfer belt 31 to contact one face of the sheet P, onto which a toner image of the sheet P is transferred in the secondary transfer nip region. The second registration roller 84b that functions as a surface mover is a rubber roller disposed on the opposite side farther from the intermediate transfer belt 31 to contact the other face of the sheet P, which is an opposite side to the face onto which the toner image of the sheet P is transferred. The first registration roller 84a, which is a metal roller, is grounded. Therefore, when the face of the sheet P onto which a toner image is transferred contacts the first registration roller 84a which is a metal roller, the surface of the sheet P onto which a toner image is transferred is neutralized, and the toner image is secondarily transferred onto the sheet P reliably.

Furthermore, in the image forming apparatus 300 according to Embodiment 1, the sheet P placed substantially horizontally on the sheet feed tray is conveyed to the pair of registration rollers 84 so as to rise. Therefore, a restoring force (rigidity of sheet) of the conveyed sheet acts toward the second registration roller 84b. As a result, the leading end of the sheet is likely to contact the second registration roller 84b to cause paper jam.

In order to prevent such paper jam, in Embodiment 1, a guide sheet 87 is disposed near the pair of registration rollers 84. The guide sheet 87 functions as a resin sheet made of polyethylene terephthalate (PET) for guiding the leading end of the sheet P to a registration nip region of the pair of registration rollers 84.

When the diameter of the second registration roller 84b is large, the rise of the second registration roller 84b from the registration nip region is gentle. When the leading end of the sheet P contacts the second registration roller 84b near the registration nip region, the leading end of the sheet P is guided to the registration nip region by the second registration roller 84b. However, as in the first embodiment, when the second registration roller 84b has a small diameter, the rise of the second registration roller 84b from the registration nip region is steep. Even when the leading end of the sheet P contacts the second registration roller 84b near the registration nip, paper jam may occur. Therefore, as illustrated in FIG. 4, in the present embodiment, the leading end of the guide sheet 87 is located near the registration nip region, and the leading end of the guide sheet 87 is brought to contact the second registration roller 84b.

A paper dust removing member 88 is disposed to remove paper dust adhering to a surface of the first registration roller 84a. The paper dust removing member 88 is a resin sheet made of polyethylene terephthalate (PET), which is similar to the guide sheet 87. The leading end of the paper dust removing member 88 is in contact with the first registration roller 84a. Paper dust scraped off by the paper dust removing member 88 falls onto a paper dust collecting box 89. Removal of paper dust adhering to the first registration roller 84a prevents transfer of the paper dust to a surface of the sheet P, onto which the toner image is transferred. Consequently, this removal of paper dust restrains disturbance of a toner image secondarily transferred onto the sheet P by paper dust.

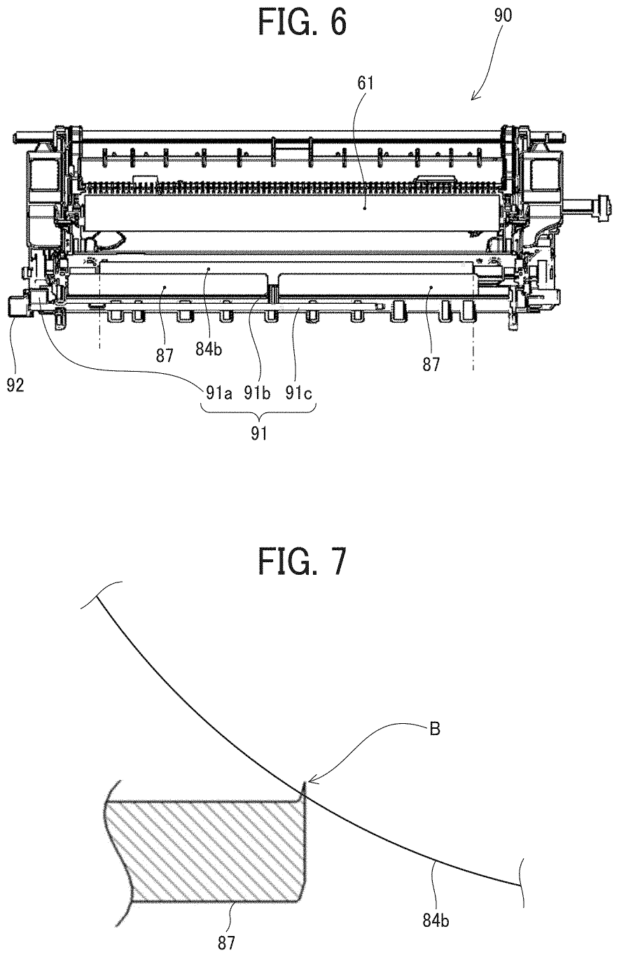

FIG. 5 is a perspective view illustrating a conveyance mechanism 90 that holds the pair of registration rollers 84 and a secondary transfer roller 61. FIG. 6 is a front view illustrating the conveyance mechanism 90, viewed from a direction indicated by arrow W of FIG. 5.

The conveyance mechanism 90 that functions as a sheet conveying device includes a sheet detection mechanism including a sheet detection member 91 and an optical sensor 92. The sheet detection member 91 is supported to be rotatable within a given range with respect to the conveyance mechanism 90, and includes a detection target portion 91a, a sheet contact unit 91b, and a rotation shaft 91c. The sheet contact unit 91b is disposed at the center in the axial direction to contact a sheet. The detection target portion 91a is detected by the optical sensor 92 that is disposed at one end in the axial direction. The detection target portion 91a and the sheet contact unit 91b are mounted on the rotation shaft 91c.

The optical sensor 92 is a transmission type sensor. As the rotation shaft 91c rotates, the detection target portion 91a is located between a light receiving element and a light emitting element of the transmission type sensor, and moves between a blocking position at which the detection target portion 91a blocks the light emitting element moving toward the light receiving element and a retraction position to which the detection target portion 91a is retracted from a position between the light receiving element and the light emitting element. In the image forming apparatus 300 according to Embodiment 1, a sheet P is conveyed by a center reference. Therefore, the sheet contact unit 91b to contact the sheet P is disposed at the center in the axial direction of the conveyance mechanism 90. According to this configuration, the sheet contact unit 91b is brought into contact with the conveyed sheet P regardless of the size of the sheet P.

When the sheet P is conveyed to a position near the registration nip region, the leading end of the sheet P comes into contact with the sheet contact unit 91b of the sheet detection member 91 to rotate the sheet detection member 91. Then, the detection target portion 91a of the sheet detection member 91 moves from the retraction position to the blocking position or from the blocking position to the retraction position. As a result, a light receiving state of the light receiving element of the optical sensor 92 changes to detect presence or absence of a sheet P. In the present embodiment, when the sheet detection mechanism does not detect a sheet P within a given time after sheet feeding is started (in other words, rotation of the sheet feed roller 82 is started), it is determined that a sheet feeding failure has occurred. In response to the determination, a given processing is executed. The guide sheet 87 is a resin sheet made of polyethylene terephthalate (PET). The sheet contact unit 91b of the sheet detection member 91 is disposed at the center in the axial direction of the sheet detection member 91. In the configuration of Embodiment 1, two guide sheets 87 are disposed with the sheet contact unit 91b of the sheet detection member 91 being interposed between the two guide sheets 87, so as to avoid the sheet contact unit 91b. Each of the guide sheets 87 is stuck to a facing surface portion of the conveyance mechanism 90 that is disposed facing a sheet P on an upstream side of the pair of registration rollers 84 with, for example, a double-sided tape.

An end portion of each of the guide sheets 87 in the axial direction is located closer to an end portion side than a roller portion of each of the registration rollers of the pair of registration rollers 84. By locating the end portion of each of the guide sheets 87 in the axial direction closer to an end portion side than the roller portion of each of the registration rollers, each of the guide sheets 87 guides a sheet P reliably.

As illustrated in FIGS. 5 and 6, by dividing the guide sheet 87 into two portions at the center in the axial direction, the length of the guide sheet 87 is reduced, and an assembling property of a sheet is enhanced. Furthermore, by dividing the guide sheet 87 into two portions at the center in the axial direction, variations in a leading end position is restrained when the guide sheet 87 is assembled while being inclined with respect to the axial direction, when compared with a case in which the guide sheet 87 is not divided.

The thickness of the guide sheet 87 is preferably 0.1 [mm] or more. When the thickness of the guide sheet 87 is less than 0.1 [mm], the guide sheet 87 is easily bent, and it is difficult to stick the guide sheet 87 to the conveyance mechanism 90. Furthermore, in a case in which a sheet P to be conveyed has strong stiffness like a thick sheet, when the leading end of the sheet P abuts against (or contacts) the guide sheet 87, the guide sheet 87 is bent largely, and the leading end of the sheet P is not guided to a registration nip region, resulting in paper jam. Therefore, by setting the thickness of the guide sheet 87 to 0.1 [mm] or more so as to have a certain thickness, even with a sheet having a good assembling property and strong stiffness like a thick sheet, the leading end of the sheet P is guided to the registration nip region preferably.

In a configuration in which the leading end of the guide sheet 87 is in contact with the second registration roller 84b according to the present embodiment, when the second registration roller 84b is rotationally driven, the guide sheet 87 slides on a surface of the second registration roller 84b, and a sliding noise is generated. This sliding noise is likely to cause noise of the image forming apparatus 300.

As described above, since the guide sheet 87 has a thickness of 0.1 [mm] or more and has stiffness, the guide sheet 87 is likely to strongly abut against (contact) the second registration roller 84b. Therefore, it is likely that the sliding noise increases.

The guide sheet 87 is generally formed by punching molding. At this time, it is likely that a burr B as illustrated in FIG. 7 is generated in the guide sheet 87. The leading end of the burr B is sharp. Therefore, when the guide sheet 87 has the burr B on a sheet side, the burr B may cause damage to the sheet P, or the sheet P may be caught by the burr, resulting in paper jam.

Therefore, the guide sheet 87 is formed by sticking a double-sided tape to the guide sheet 87 such that a surface to be a registration roller side is specified, and then punching molding is performed such that the guide sheet 87 has a burr on the side to which the double-sided tape is stuck. As a result, the guide sheet 87 has no burr B on the sheet side, and therefore prevents paper jam of the sheet and damage to the sheet due to the burr B.

However, when the guide sheet 7 has the burr B on the second registration roller 84b side, the burr B may come into contact with the second registration roller 84b, and a large sliding noise may be generated. Furthermore, the second registration roller 84b may be scraped off by the burr B, which may cause the second registration roller 84b to reach the end of a service life early or may change a surface speed of the second registration roller 84b.

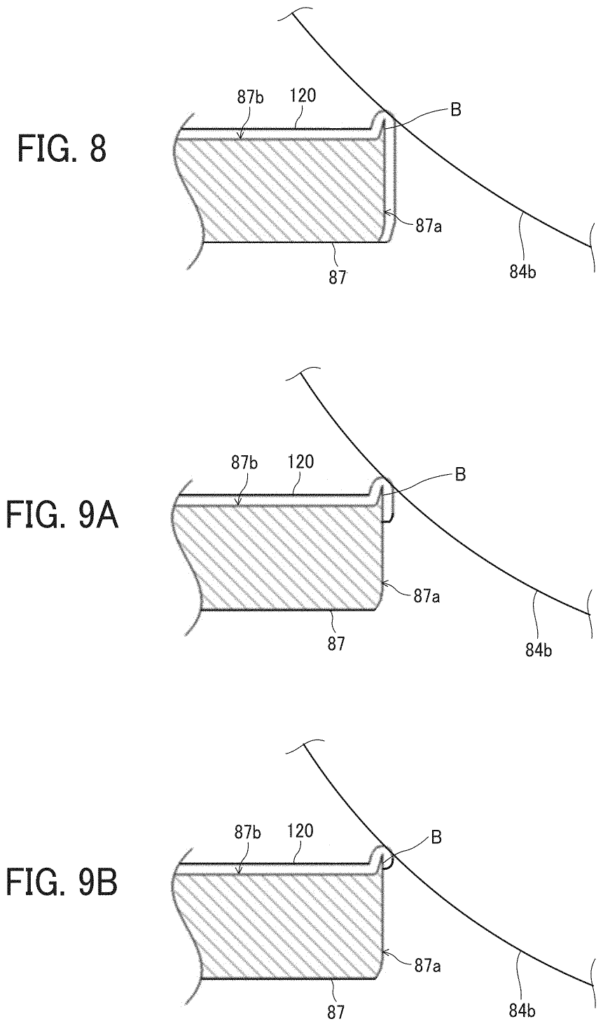

Therefore, in the present embodiment, as illustrated in FIG. 8, a coating layer 120 is disposed at least at a contact portion of the guide sheet 87 in contact with the second registration roller 84b. In the example of FIG. 8, the coating layer 120 is disposed on a leading end face 87a of the guide sheet and near a leading end portion of an opposite-side face 87b opposite to a sheet-facing-side face. According to this configuration, the leading end of the guide sheet 87 that is a contact portion in which burr B is generated is covered with the coating layer 120. By forming the coating layer 120 as illustrated in FIG. 8, the burr B at the leading end of the guide sheet 87 is covered with the coating layer 120. By covering the burr B with the coating layer 120, the sharpness of the burr B is reduced, and catch of the leading end of the guide sheet by the second registration roller 84b is restrained. As a result, resistance of the guide sheet 87 while sliding and vibration of the guide sheet 87 are restrained, and a sliding noise is reduced. Furthermore, by reducing the sharpness, scraping of the second registration roller 84b is reduced.

An arithmetic average roughness Ra of the coating layer 120 based on JIS B0601 (2001) is 0.01 [μm] to 1.0 [μm]. By setting the arithmetic average roughness Ra of the coating layer 120 to 1.0 [μm] or less, the resistance and vibration of the guide sheet during sliding is reduced, a friction coefficient with the second registration roller 84b is reduced, and generation of a sliding noise is restrained. In particular, the arithmetic average roughness Ra of the coating layer 120 is preferably in a range of 0.01 [μm] to 0.50 [μm], 0.01 [μm] to 0.40 [μm], or 0.01 [μm] to 0.30 [μm]. Further, the arithmetic average roughness Ra of the coating layer 120 is more preferably in a range of 0.01 [μm] to 0.25 [μm] or 0.01 [μm] to 0.20 [μm] from a viewpoint of being able to reduce a rubbing noise generated by surface roughness between the second registration roller 84b and the guide sheet 87 to achieve quietness.

Here, the arithmetic average roughness Ra of the coating layer 120 may fall in the above range immediately after the coating film is formed by coating. However, after the coating layer 120 is formed, the arithmetic average roughness Ra of the coating layer 120 may fall in the above range (particularly in the preferable range) after the coating layer 120 is subjected to surface polishing or sliding with another part.

A difference Δμ, between a static friction coefficient μs and a dynamic friction coefficient μd of the coating layer 120 with the second registration roller 84b (μs-μd) is preferably 0.12 or less. By setting the difference Δμ, in friction coefficient to 0.12 or less, occurrence of a stick-slip phenomenon due to sliding of the guide sheet 87 with the second registration roller 84b is restrained during re-rotation of the second registration roller 84b after rotation of the second registration roller 84b has been stopped. According to this setting, generation of a noise (chattering noise) generated by the stick-slip phenomenon is reduced.

The coating layer 120 preferably has a film thickness of 50 [μm] or less. By setting the film thickness of the coating layer 120 to 50 [μm] or less, there is little influence of the film thickness, for example, an increase in contact pressure to the second registration roller 84b, and therefore the dimensions of the second registration roller 84b is not changed.

The coating layer 120 preferably has a film thickness of 20 [μm] or more. By setting the film thickness of the coating layer 120 to 20 [μm] or more, a function of the coating layer 120 for reducing the surface roughness is performed more reliably.

It is to be noted that the coating film illustrated in FIG. 8 is an example, and the coating film is disposed at least on a leading end of the guide sheet 87, that is a contact portion of the guide sheet 87 with the second registration roller 84b.

For example, as illustrated in FIG. 9A, the coating film may be disposed on a part of the leading end face 87a of the guide sheet 87 on the second registration roller side and on a leading end side of the opposite-side face 87b on the opposite side to the sheet-facing-side face. Even with this configuration, the sliding portion with the second registration roller 84b and the burr B at the leading end portion is covered with the coating layer 120. As illustrated in FIG. 9B, the leading end side of the opposite-side face 87b opposite to the sheet-facing-side face and the portion of the burr B may be covered with the coating layer 120.

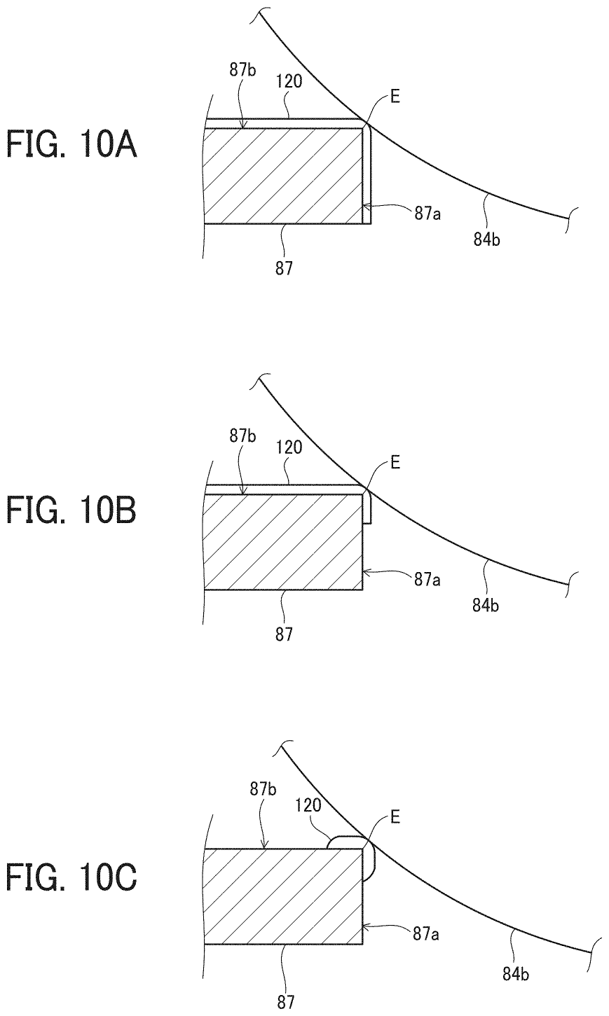

FIGS. 10A, 10B, and 10C are diagrams illustrating examples of forming a coating layer of a guide sheet having no burr at the leading end of the guide sheet 87. FIG. 10A illustrates an example in which the coating layer 120 is disposed on the leading end face 87a of the guide sheet 87 and on the leading end side of the opposite-side face 87b that is opposite to the sheet-facing-side face. FIG. 10B illustrates an example in which the coating layer 120 is disposed on a part of the leading end face 87a of the guide sheet 87 on the second registration roller 84b side and on the leading end side of the opposite-side face 87b on the opposite side to the sheet-facing-side face. FIG. 10C illustrates an example in which the coating layer 120 is disposed only on the leading end E of the guide sheet 87.

In the present embodiment, the coating layer 120 is formed by applying a coating liquid. As illustrated in FIGS. 10A and 10B, a portion covering the leading end E (i.e., a side formed by the leading end face and the opposite-side face 87b opposite the sheet-facing-side face) is rounded due to surface tension of the liquid. According to this configuration, a case in which the rounded coating layer 120 contacts the second registration roller 84b rather than a case in which a sharp leading end of the coating layer 120 slides on the second registration roller 84b restrains catch by the surface of the second registration roller 84b. This configuration restrains generation of a sliding noise and scraping of the second registration roller 84b.

Further, it is preferable that the coating layer 120 does not shift to the sliding second registration roller 84b, in other words, the coating layer 120 stays away from the second registration roller 84b. According to this configuration, the function of the coating layer 120 is maintained for a long period of time, and generation of a sliding noise is reduced for a long period of time.

Similar to the guide sheet 87, the paper dust removing member 88 which is a PET resin sheet may have the above-described coating layer 120 on a leading end of the paper dust removing member 88, which is a contact portion to contact the first registration roller 84a. According to this configuration, generation of a sliding noise with the first registration roller 84a is reduced, and a noise of the image forming apparatus 300 is restrained.

The coating layer 120 includes at least a resin binder and a solid lubricant. As the resin binder, a solvent-based resin or an aqueous resin can be used without any particular limitation, but an aqueous emulsion type resin is preferably used. The resin binder forms a coating layer by curing and functions as a binder resin such as solid particles. The resin binder is preferably an aqueous emulsion type coating composition from a viewpoint of quietness of the coating layer.

The resin binder is not particularly limited, but examples thereof include one or more resin binders selected from a polyamideimide resin, an epoxy resin, a silicone resin, a phenol resin, a polyacrylic resin, a polyurethane resin, a polyolefin resin, and modified products thereof.

The solid lubricant is not particularly limited, and one solid lubricant may be used, or two or more solid lubricants may be used in combination. Specific examples thereof include molybdenum disulfide, tungsten disulfide, calcium stearate, mica, graphite, polytetrafluoroethylene (PTFE), other lubricating resins, and a complex oxide having an oxygen-defective perovskite structure (SrxCa1-xCuOy and the like).

Preferable examples of the solid lubricant include fine particles of an organic compound such as a fluorocarbon resin (particularly, polytetrafluoroethylene, tetrafluoroethylene hexafluoropropylene copolymer, or the like), a polyethylene resin, a polyamide resin, a polypropylene resin, a polyimide resin, or a silicone resin, fine particles of an inorganic compound such as molybdenum disulfide, graphite, silicon oxide, aluminum oxide, boron nitride, or zinc oxide, fine particles of a metal such as lead, and a mixture thereof. In particular, at least one solid lubricant selected from a fluorocarbon resin, a polyethylene resin, a polyamide resin, molybdenum disulfide, graphite, aluminum oxide, boron nitride, zinc oxide, titanium oxide, zirconium oxide, and a mixture thereof is preferably used. It is to be noted that fine particles of an inorganic compound, particularly molybdenum disulfide, graphite, silicon oxide, aluminum oxide, boron nitride, zinc oxide, and the like are preferable from a viewpoint of quietness of a coating layer obtained.

The solid lubricant has an average particle diameter of preferably 15 μm or less, more preferably from 0.2 μm to 10 μm. It is to be noted that the average particle diameter here means a volume average particle diameter measured using a laser diffraction particle size distribution measuring apparatus or a particle diameter observed using a scanning electron microscope.

The coating layer 120 may also include solid particles other than a solid lubricant. These solid particles are components that impart a desired function to the coating layer. These solid particles are components that impart a desired function to the coating layer. The types of the solid particles are not particularly limited, but examples thereof include functional particles of a reinforcing filler, a thickener, an anti-wear agent, a pigment, a colorant, an ultraviolet absorber, a thermally conductive filler, a conductive filler, and an insulator. It is to be noted that some of the particles may be blended as a plurality of functional particles.

The shapes of the solid lubricant and other solid particles are not particularly limited, and may be any shape such as a particle shape, a plate shape, a needle shape, or a fiber shape. When the solid particles have an anisotropic shape such as a plate shape, a needle shape, or a fiber shape, the solid particles can have an aspect ratio of 1.5 or more, 5 or more, or 10 or more.

The coating layer may be formed by a known method such as spray coating, coating with a brush, a roller, or impregnation coating. By using a solvent-based resin or an aqueous resin as the resin binder, a coating layer can be formed by a relatively simple process of coating, drying, and curing. Furthermore, by inclusion of the solid lubricant, the coating layer can have lubricity, the friction coefficient between the coating layer and the registration roller can be reduced, and a sliding noise can be reduced.

### Embodiment 2

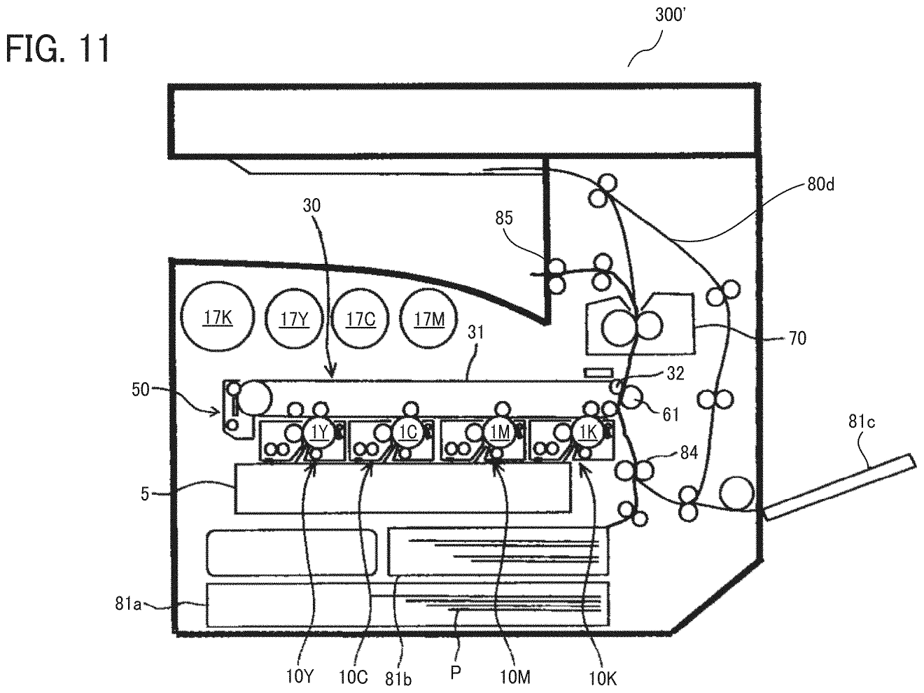

FIG. 11 is a diagram illustrating a schematic configuration of an image forming apparatus 300′ according to Embodiment 2 of this disclosure.

The image forming apparatus 300′ according to Embodiment 2 also includes four image forming units 10Y, 10C, 10M, and 10K for forming toner images of yellow (Y), cyan (C), magenta (M), and black (K). It is to be noted that the order of the colors Y, C, M, and K is not limited to the order in the image forming apparatus 300′ illustrated in FIG. 11, but may be any other order.

Similar to the configuration of the image forming apparatus 300 according to Embodiment 1, each of the image forming units 10Y, 10M, 10C, and 10K of the image forming apparatus 300′ according to Embodiment 2 includes a charging roller functioning as a charger, a developing device, and a cleaning device, which are disposed around the photoconductor drums 1Y, 1M, 1C, and 1K. The image forming units 10Y, 10M, 10C, and 10K are configured as process cartridges in which the photoconductor drums 1Y, 1M, 1C, and 1K and the respective charging rollers, the respective developing devices, and the respective cleaning devices disposed around the photoconductor drums 1Y, 1M, 1C, and 1K are held by a common holding member as a single unit. The image forming units 10Y, 10M, 10C, and 10K are detachably attached to the apparatus body of the image forming apparatus 300′, and consumable parts of each image forming unit 10 are replaceable at the same time when each of the image forming units 10Y, 10M, 10C, and 10K has reached the end of the service life.

An optical writing device 5 is disposed below the image forming units 10Y, 10C, 10M, and 10K. The optical writing device 5 includes a light source, a polygon mirror, an f-O lens, and a reflecting mirror. Respective surfaces of the photoconductor drums 1Y, 1C, 1M, and 1K of the respective colors are optically scanned with a laser beam based on image data. By this optical scanning, electrostatic latent images for yellow, cyan, magenta, and black are formed on the photoconductor drums 1Y, 1C, 1M, and 1K.

An intermediate transfer unit 30 is disposed above the image forming units 10Y, 10C, 10M, and 10K. The intermediate transfer unit 30 transfers respective toner images from the photoconductor drums 1Y, 1C, 1M, and 1K onto the sheet P via an intermediate transfer belt 31. While being stretched by a plurality of rollers, the intermediate transfer belt 31 is endlessly moved counterclockwise in the drawing by rotation of at least one of these rollers. The intermediate transfer unit 30 includes the intermediate transfer belt 31 as described above, a primary transfer roller 34, a brush roller, and a belt cleaning device 50 including a cleaning blade.

The intermediate transfer belt 31 is disposed in contact between the primary transfer roller 34 and the photoconductor drums 1Y, 1C, 1M, and 1K. As a result, respective primary transfer nip regions for Y, M, C, and K are areas of contact in which the photoconductor drums 1Y, 1C, 1M, and 1K contact a surface of the intermediate transfer belt 31. The intermediate transfer unit 30 includes a secondary transfer roller 61 that is disposed downstream from the image forming unit 10K for black toner image in a belt moving direction and outside a belt loop near a secondary transfer backup roller 32. The intermediate transfer belt 31 is interposed between the secondary transfer roller 61 and the secondary transfer backup roller 32 to form a secondary transfer nip.

A fixing device 70 is disposed above the secondary transfer roller 61. The fixing device 70 includes a fixing roller and a pressure roller. The fixing roller and the pressure roller rotate while contacting each other to form a fixing nip region. The fixing roller includes a halogen heater. Electric power is supplied from a power source to the heater to provide a given temperature to a surface of the fixing roller. The fixing roller forms the fixing nip region with the pressing roller.

Sheet feed trays 81a and 81b that contain a plurality of sheets P including a sheet P that functions as a recording medium on which an output image is recorded, a sheet feed roller, the pair of registration rollers 84 are disposed in a lower portion of the apparatus body of the image forming apparatus 300′. The bypass tray 81c is disposed on a side surface of the apparatus body of the image forming apparatus 300′ to manually feed sheets from the side surface of the apparatus body of the image forming apparatus 300′.

Toner supply containers 17Y, 17C, 17M, and 17K are disposed in an upper portion of the apparatus body of the image forming apparatus 300′ to supply toner to the respective developing devices of the image forming units 10Y, 10C, 10M, and 10K. The apparatus body of the image forming apparatus 300′ further includes a waste toner bottle and a power supply unit.

Next, a description is given of operations of the image forming apparatus 300′.

First, a surface of the photoconductor drum 1 is uniformly charged in a contact area between the charging roller and the photoconductor drum 1. The surface of the photoconductor drum 1 charged to a given potential is scanned by the optical writing device 5 with a laser beam based on image data, and an electrostatic latent image is thereby formed on the photoconductor drum 1. When the surface of the photoconductor drum 1 carrying the electrostatic latent image reaches the developing device as the photoconductor drum 1 rotates, the developing device supplies toner to the electrostatic latent image on the surface of the photoconductor drum 1. As a result, a toner image is formed on the surface of the photoconductor drum 1. An appropriate amount of toner is supplied into the developing device from the toner supply container 17 according to the output of a toner density sensor.

The above operation is performed at respective given timings in the image forming units 10Y, 10C, 10M, and 10K. As a result, toner images of Y, C, M, and K are formed on the surfaces of the photoconductor drums 1Y, 1C, 1M, and 1K, respectively. These Y, C, M, and K toner images are sequentially overlaid onto the surface of the intermediate transfer belt 31 in the primary transfer nip regions for Y, C, M, and K for primary transfer. This primary transfer is performed by applying a voltage having a polarity opposite to the polarity of toner to the primary transfer roller 34 by a transfer power supply.

The sheet P is conveyed from one of the sheet feed trays 81a and 81b and the bypass tray 81c, and temporarily stops when the sheet P reaches the pair of registration rollers 84. Then, the pair of registration rollers 84 rotates at a given timing to feed the sheet P toward the secondary transfer nip region.

The Y, C, M, and K toner images sequentially overlaid on the intermediate transfer belt 31 are secondarily transferred onto the sheet P at the secondary transfer nip region in which the secondary transfer roller 61 contacts the intermediate transfer belt 31. This secondary transfer is performed by applying a voltage having a polarity opposite to the polarity of toner to the secondary transfer roller 61 by a secondary transfer power supply. After passing through the secondary transfer nip region, the sheet P is conveyed toward the fixing device 70 and sandwiched by the fixing nip region. The toner image on the sheet P is heated and fixed by application of heat by the fixing roller at the fixing nip region. In a case in which a single-side printing is performed, the sheet P on which the toner image has been fixed is ejected to the outside of the apparatus body of the image forming apparatus 300′. In a case in which a duplex printing is performed, the sheet P is conveyed to a duplex sheet conveyance passage 80d by the conveying rollers, and is inverted by the duplex sheet conveyance passage 80d. Then, the sheet P is ejected to the outside of the apparatus body of the image forming apparatus 300′ after an image is formed on the opposite face to the face on which the image has been formed previously, as described above.

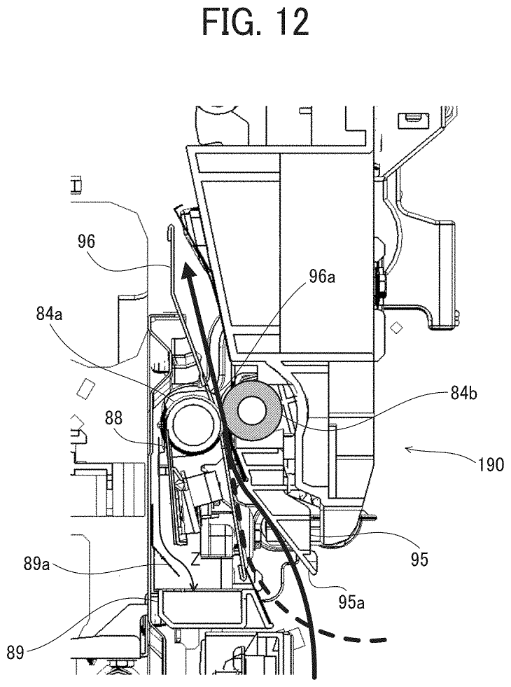

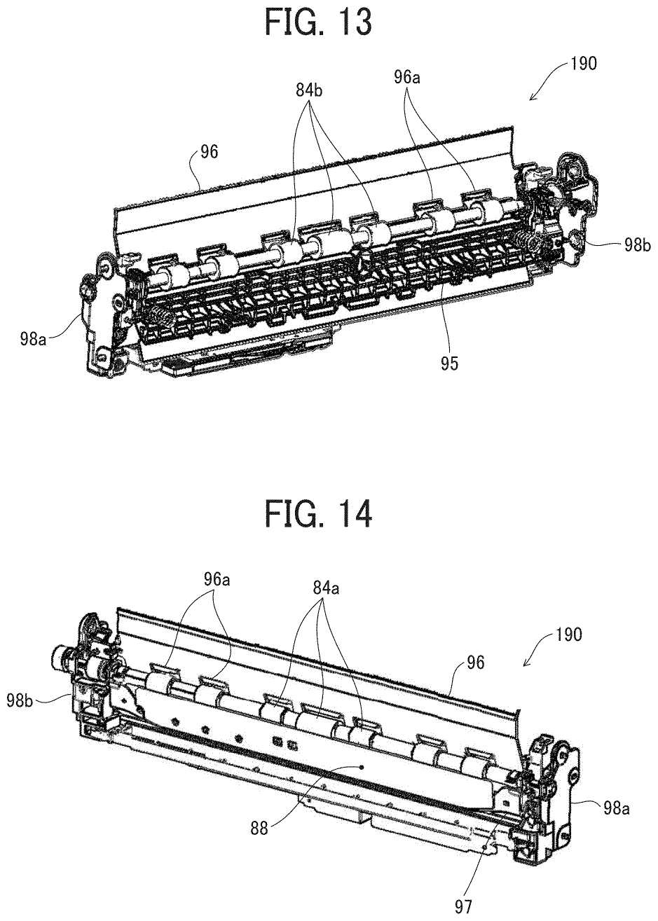

FIG. 12 is a diagram illustrating a schematic configuration of the image forming apparatus 300′, focusing the pair of registration rollers 84 and an area near the pair of registration rollers 84, according to Embodiment 2 of this disclosure. FIG. 13 is a perspective view illustrating a conveyance mechanism 190, viewed from the second registration roller 84b of the pair of registration rollers 84. FIG. 14 is a perspective view illustrating the conveyance mechanism 190, viewed from the first registration roller 84a of the pair of registration rollers 84.

As illustrated in FIGS. 13 and 14, in Embodiment 2, a plurality of first registration rollers 84a and a plurality of second registration rollers 84b are disposed at given intervals in the axial direction of the conveyance mechanism 190. The conveyance mechanism 190 that functions as a sheet conveying device includes a metal guide 96 disposed on the first registration roller side and an upstream side guide 95 made of a resin disposed on the second registration roller side and facing the metal guide 96 on the upstream side of the registration nip region. A hole 96a is formed in the metal guide 96 at a position facing each of the first registration rollers 84a. Each of the first registration rollers 84a protrudes from the hole 96a and is in contact with each corresponding one of the second registration rollers 84b.

The metal guide 96 is grounded. When the face of the conveyed sheet P onto which a toner image is transferred contacts the metal guide 96, the face of the sheet P onto which the toner image is transferred is neutralized. Thus, the toner image is secondarily transferred onto the sheet P reliably.

As illustrated in FIGS. 12 and 14, the conveyance mechanism 190 includes a paper dust removing member 88 that is a resin sheet to remove paper dust adhering to the first registration roller 84a. The paper dust removing member 88 is stuck to a holder 97 (see FIG. 14) disposed so as to extend over a pair of support members 98a and 98b rotatably supporting the pair of registration rollers 84 and disposed at both ends in the axial direction, and the leading end of the paper dust removing member 88 is in contact with the first registration roller 84a.

As illustrated in FIG. 12, a paper dust collecting box 89 is disposed below the paper dust removing member 88. A paper dust guide sheet 89a formed of a resin sheet is disposed on a wall surface of the apparatus body facing the paper dust removing member 88. The paper dust guide sheet 89a guides paper dust removed by the paper dust removing member 88 to the paper dust collecting box 89.

The paper dust removed (scraped off) from the first registration roller 84a by the paper dust removing member 88 is guided by the paper dust guide sheet 89a, dropped and collected to the paper dust collecting box 89, as indicated by arrow Z in FIG. 12.

Similar to Embodiment 1, in Embodiment 2, removal of paper dust adhering to the first registration roller 84a prevents transfer of the paper dust to the surface of the sheet P, onto which the toner image is transferred. Consequently, this removal of paper dust restrains disturbance of a toner image secondarily transferred onto the sheet P by paper dust.

Furthermore, a coating layer, which is a similar coating layer in Embodiment 1, is disposed at a contact portion at which the paper dust removing member 88 which is a resin sheet contacts the first registration roller 84a. This configuration restrains generation of a sliding noise with the first registration roller 84a, and reduces a noise of the image forming apparatus 300′.

As illustrated in FIG. 12, the guide surface 95a of the upstream side guide 95 is inclined on an upstream side in the sheet conveying direction such that an extending direction of the guide surface 95a hits the metal guide 96. As indicated with a solid line in FIG. 12, a sheet conveyed from either one of the sheet feed trays 81a and 81b comes into contact with the guide surface 95a of the upstream side guide 95 on an upstream side in the sheet conveying direction. The sheet in contact with the guide surface 95a is guided toward the metal guide 96 and comes into contact with the metal guide 96. Then, the surface of the sheet P onto which the toner image is transferred enters the registration nip region while sliding on the metal guide 96. As a result, after the sheet P has been conveyed from the sheet feed trays 81a and 81b, the surface of the sheet P onto which the toner image is transferred is neutralized by the metal guide 96. Thus, the toner image is secondarily transferred onto the sheet P reliably.

Furthermore, the sheet P conveyed through the bypass tray 81c and the duplex sheet conveyance passage 80d is conveyed between the upstream side guide 95 and the metal guide while being curved from the right side in FIG. 12 as indicated by a broken line in FIG. 12. Therefore, the sheet P is in contact with the metal guide 96 by a restoring force of the sheet P, and the surface of the sheet P onto which the toner image is transferred enters the registration nip region while sliding on the metal guide 96. Therefore, after the sheet P has been conveyed through the bypass tray 81c and the duplex sheet conveyance passage 80d, the surface of the sheet P onto which the toner image is transferred is also neutralized by the metal guide 96. Thus, the toner image is secondarily transferred onto the sheet P reliably.

A leading end of the sheet conveyed through the bypass tray 81c and the duplex sheet conveyance passage 80d enters the registration nip region with the sheet restoring force applied to the first registration roller 84a side. Therefore, the leading end of the sheet P is likely to abut against (contact) the first registration roller 84a to cause paper jam. However, in Embodiment 2, as illustrated in FIG. 14, a plurality of first registration rollers 84a is disposed at given intervals, and the metal guide 96 is also located between the plurality of pair of registration rollers 84. With such a configuration, the leading end of the sheet P is guided by the metal guide 96 up to just before the registration nip region, restraining occurrence of paper jam caused by contact of the leading end of the sheet P to the first registration roller 84a.

It is to be noted that the above description describes an example in which this disclosure is applied to a resin sheet (for example, the paper dust removing member 88 and the guide sheet 87) in contact with a registration roller. However, the configuration of this disclosure is not limited thereto. For example, the present invention can be applied to a resin sheet that guides a sheet in contact with a surface mover such as a conveying roller, a secondary transfer roller, or a fixing roller. Furthermore, this disclosure is also applied to a resin sheet or the like that removes foreign materials such as paper dust adhering to a surface in contact with a surface mover such as a photoconductor drum, a developing roller, a charging roller, an intermediate transfer belt, a sheet conveying roller, a fixing roller, or a secondary transfer roller.

The configurations according to the above-descried embodiments are not limited thereto. This disclosure can achieve the following aspects effectively.

Aspect 1.

A resin sheet (for example, the guide sheet 87 and the paper dust removing member 88) includes a coating layer (for example, the coating layer 120) disposed at a contact portion at which the resin sheet contacts a surface mover (for example, the pair of registration rollers 84) having a surface that moves endlessly.

According to Aspect 1, by disposing the coating layer at the contact portion of the resin sheet with the surface mover (for example, at least one roller of the pair of registration rollers 84), the enhance slidability between the resin sheet and the surface of the surface mover is enhanced, and therefore a sliding noise is restrained.

Aspect 2.

In Aspect 1, the coating layer (for example, the coating layer 120) stays away from the surface mover (for example, at least one roller of the pair of registration rollers 84).

According to this configuration, as described in the embodiments above, the function of the coating layer is maintained for a long period of time, and therefore generation of a sliding noise is reduced for a long period of time.

Aspect 3.

In Aspect 1 or Aspect 2, the coating layer (for example, the coating layer 120) has an arithmetic average roughness Ra of 0.01 [μm] or greater and 1.0 [μm] or smaller, based on JIS B0601 (2001).

According to this configuration, as described in the embodiments above, the resistance and vibration during sliding are reduced, and therefore a friction coefficient with a surface mover (for example, the second registration roller 84b) is reduced. Accordingly, generation of a sliding noise is restrained.

Aspect 4.

In any one of Aspect 1 to Aspect 3, a difference between a kinetic coefficient of friction and a static coefficient of friction of the coating layer (for example, the coating layer 120) is 0.12 or smaller.

According to this configuration, as described in the embodiments above, occurrence of a stick-slip phenomenon in the resin sheet due to sliding with the surface mover (for example, at least one roller of the pair of registration rollers 84) is restrained when driving of the surface mover starts. According to this setting, generation of a noise (chattering noise) generated by the stick-slip phenomenon is reduced.

Aspect 5.

In the resin sheet (for example, the guide sheet 87 and the paper dust removing member 88) according to any one of Aspect 1 to Aspect 4, the coating layer (for example, the coating layer 120) includes a resin containing a solid lubricant.

According to this configuration, as described in the embodiments above, the lubricity is applied to the coating layer (for example, the coating layer 120), and therefore the friction coefficient between the resin sheet and a surface mover (for example, at least one roller of the pair of registration rollers 84) is reduced. Accordingly, occurrence of a sliding noise is reduced.

Aspect 6.

In any one of Aspect 1 to Aspect 5, the coating layer (for example, the coating layer 120) has a film thickness of 50 [μm] or smaller.

According to this configuration, as described in the embodiments above, there is little influence of the film thickness, for example, an increase in contact pressure to a surface mover (for example, the second registration roller 84b), and therefore the dimensions of the surface mover is not changed.

Aspect 7.

In any one of Aspect 1 to Aspect 6, the coating layer (for example, the coating layer 120) has a film thickness of 20 [μm] or greater.

According to this configuration, as described in the embodiments above, by setting the film thickness of the coating layer (for example, the coating layer 120) to 20 [μm] or greater, a function of the coating layer for reducing the surface roughness is performed more reliably.

Aspect 8.

In any one of Aspect 1 to Aspect 7, the contact portion is located at an end portion of the resin sheet (for example, the guide sheet 87 and the paper dust removing member 88).

As described in the embodiments above, it is likely that a burr is generated at the end portion of the resin sheet. When the contact portion is located at the end portion of the resin sheet, a sliding noise increases easily due to the burr or a surface mover (for example, at least one roller of the pair of registration rollers 84) is scraped easily. However, as described in Aspect 1, by covering the contact portion with the coating layer, a decrease in a sliding noise is restrained effectively.

Aspect 9.

In any one of Aspect 1 to Aspect 8, the resin sheet (for example, the guide sheet 87 and the paper dust removing member 88) includes polyethylene terephthalate (PET).

According to this configuration, the resin sheet includes the flexibility.

Aspect 10.

In any one of Aspect 1 to Aspect 10, the resin sheet (for example, the guide sheet 87 and the paper dust removing member 88) has a thickness of 0.1 [mm] or greater.

According to this configuration, as described in the embodiments above, the resin sheet has a certain degree of stiffness, and the assembling property of a sheet is enhanced. Furthermore, the resin sheet has a thickness of 0.1 [mm] or more and has stiffness, and therefore a sliding noise is easily generated. However, by disposing a coating layer, generation of a sliding noise is effectively restrained.

Aspect 11.

In any one of Aspect 1 to Aspect 11, a surface of the surface mover (for example, the second registration roller 84b) is made of a rubber material.

When the surface mover is made of rubber, a sliding noise is easily generated. However, by disposing a coating layer, generation of the sliding noise is effectively restrained.

Aspect 12.

A sheet conveying device (for example, the conveyance mechanism 90 and the conveyance mechanism 190) includes a sheet conveying roller (for example, the pair of registration rollers 84) configured to convey a sheet, and the resin sheet (for example, the guide sheet 87 and the paper dust removing member 88) according to any one of Aspect 1 to Aspect 11. The resin sheet is configured to contact the sheet conveying roller.

According to this configuration, a noise of the sheet conveying device is restrained.

Aspect 13.

In Aspect 12, the sheet conveying roller to contact the resin sheet is a registration roller.

According to this configuration, a sliding noise with the registration roller is restrained.

Aspect 14.

An image forming apparatus (for example, the image forming apparatus 300) includes a sheet conveying roller (for example, the pair of registration rollers 84) configured to convey a sheet, and the resin sheet according to any one of Aspect 1 to Aspect 12.

According to this configuration, a noise of the image forming apparatus is restrained.

The embodiments described above are presented as an example to implement this disclosure. The embodiments described above are not intended to limit the scope of the invention. These novel embodiments can be implemented in various other forms, and various omissions, replacements, or changes can be made without departing from the gist of the invention. These embodiments and their variations are included in the scope and gist of the invention, and are included in the scope of the invention recited in the claims and its equivalent.

What is claimed is:

1. A resin sheet comprising:
a coating layer disposed at a contact portion at which the resin sheet contacts a surface mover having a surface that moves endlessly.

2. The resin sheet according to claim 1,
wherein the coating layer is configured to be resistant to sliding of the surface mover.

3. The resin sheet according to claim 1,
wherein the coating layer has an arithmetic average roughness Ra of 0.01 μm or greater and 1.0 μm or smaller, based on JIS B0601 (2001).

4. The resin sheet according to claim 1,
wherein a difference between a kinetic coefficient of friction and a static coefficient of friction of the coating layer is 0.12 or smaller.

5. The resin sheet according to claim 1,
wherein the coating layer includes a resin containing a solid lubricant.

6. The resin sheet according to claim 1,
wherein the coating layer has a film thickness of 50 μm or smaller.

7. The resin sheet according to claim 1,
wherein the coating layer has a film thickness of 20 μm or greater.

8. The resin sheet according to claim 1,
wherein the contact portion is located at an end portion of the resin sheet.

9. The resin sheet according to claim 1,
wherein the resin sheet includes polyethylene terephthalate (PET).

10. The resin sheet according to claim 1,
wherein the resin sheet has a thickness of 0.1 mm or greater.

11. The resin sheet according to claim 1,
wherein a surface of the surface mover is made of a rubber material.

12. A sheet conveying device comprising:
a sheet conveying roller configured to convey a sheet; and
the resin sheet according to claim 1, configured to contact the sheet conveying roller.

13. The sheet conveying device according to claim 12,
wherein the sheet conveying roller configured to contact the resin sheet is a registration roller.

14. An image forming apparatus comprising:
a sheet conveying roller configured to convey a sheet; and
the resin sheet according to claim 1, configured to contact the sheet conveying roller.
